(19) United States
(12) Patent Application Publication
(10) Pub. No.: US 2026/0292946 A1
(43) Pub. Date: Sep. 24, 2026

(54) METHOD, SYSTEM AND DEVICE FOR REGULATING DIMMING CURRENT, STORAGE MEDIUM, AND DIMMABLE POWER SUPPLY

(71) Applicant: SHENZHEN SUNRICHER TECHNOLOGY CO., LTD., Shenzhen, Guangdong (CN)

(72) Inventor: Fei GONG, Shenzhen, Guangdong (CN)

(21) Appl. No.: 19/151,884

(22) PCT Filed: Oct. 8, 2022
(86) PCT No.: PCT/CN2022/123881

§ 371 Date: Jul. 29, 2025

(51) Int. Cl. H05B 45/10; H05B 47/19

(52) U.S. Cl. CPC H05B 45/10; H05B 47/19

(57) ABSTRACT

A method, a system and a device for regulating a dimming current, a computer-readable storage medium and a dimmable power supply. The method includes steps of: obtaining current regulation configuration information of target luminaires, where the target luminaires are luminaires powered by the dimmable power supply; and regulating the dimming current of each of the target luminaires according to the current regulation configuration information. According to the present application, the corresponding current regulation configuration information may be pre-set according to the performance difference of each target luminaire. The dimmable power supply, after obtaining the current regulation configuration information, can regulate the dimming current of each of the target luminaires according to the current regulation configuration information, so that the target luminaires can maintain strong consistency even in deep dimming scenarios, effectively enhancing the user experience.

### CROSS-REFERENCE TO RELATED APPLICATIONS

This application is the national phase entry of International Application No. PCT/CN 2022/123881, filed on Oct. 8, 2022, the entire content of which is incorporated herein by reference.

### FIELD OF TECHNOLOGY

The following relates to the field of lighting control technology, more particularly to a method, a system and a device for regulating a dimming current, a computer-readable storage medium and a dimmable power supply.

### BACKGROUND

Currently, the replacement of fluorescent daylight luminaires and fluorescent energy-saving luminaires with LED lighting has become an inevitable trend. Since LED components can rapidly adapt to current variations during operation, designing dimming functions for LED driver power supplies is highly convenient. The use of LED dimmable lights brings convenience to energy-saving and low-carbon work and lifestyles.

However, in practical applications, there are often certain performance differences among different LED luminaires. When the dimming current is relatively high, these differences are not significant. However, when the dimming current is low, especially in deep dimming scenarios, these differences become increasingly apparent. Due to variations in the minimum ignition current (i.e., the minimum current required to make the luminaire emit light) among luminaires powered by the same dimmable power supply, achieving synchronized on-off effects is impossible. Moreover, even when all luminaires have reached the minimum ignition current, their brightness levels may still appear uneven, resulting in a poor user experience.

### SUMMARY

In view of this, the embodiments of the present application provide a method, a system and a device for regulating a dimming current, a computer-readable storage medium and a dimmable power supply, aiming to address the issue of noticeable performance differences among different luminaires in deep dimming scenarios, which leads to poor user experience.

In accordance with a first aspect of the embodiments of the present application, a method for regulating a dimming current, which is applied to a dimmable power supply that is configured in advance. The method may include steps of:
obtaining current regulation configuration information of target luminaires, where the target luminaires are luminaires powered by the dimmable power supply; and
regulating the dimming current of each of the target luminaires according to the current regulation configuration information.

In a specific implementation of the first aspect, the dimmable power supply may include a first communication module;

The step of obtaining the current regulation configuration information of the target luminaires may include a step of:
performing, through the first communication module, information interaction with a second communication module in a configuration device that is configured in advance to obtain the current regulation configuration information stored in the configuration device.

In a specific implementation of the first aspect, the first communication module may be a first near field communication (NFC) module, and the second communication module may be a second NFC module.

In a specific implementation of the first aspect, the current regulation configuration information may include a regulation direction and a regulation amount of the dimming current.

The step of regulating the dimming current of each of the target luminaires according to the current regulation configuration information may include the following steps:
extracting a first regulation direction and a first regulation amount corresponding to a first target luminaire from the current regulation configuration information, where the first target luminaire is any one of the target luminaires; and
regulating the dimming current of the first target luminaire according to the first regulation direction and the first regulation amount.

In a specific implementation of the first aspect, the regulation direction may be to increase the dimming current or to decrease the dimming current.

In a specific implementation of the first aspect, the regulation amount may be an absolute regulation amount or a relative regulation amount.

In accordance with a second aspect of the embodiments of the present application, a system for regulating a dimming current is provided, which may include: a configuration device, a dimmable power supply and target luminaires. The target luminaire are luminaires powered by the dimmable power supply;

The configuration device is configured to store current regulation configuration information of the target luminaires.

The dimmable power supply is configured to obtain the current regulation configuration information stored in the configuration device, and regulate the dimming current of each of the target luminaires according to the current regulation configuration information.

In a specific implementation of the second aspect, the dimmable power supply may include a first communication module, and the configuration device may include a second communication module.

The dimmable power supply is specifically configured to: perform information interaction with the second communication module through the first communication module to obtain the current regulation configuration information stored in the configuration device.

In a specific implementation of the second aspect, the first communication module may be a first NFC module, and the second communication module may be a second NFC module.

In a specific implementation of the second aspect, the current regulation configuration information may include a regulation direction and a regulation amount for the dimming current.

The dimmable power supply is also specifically configured to: extract a first regulation direction and a first regulation amount corresponding to a first target luminaire from the current regulation configuration information, where the first target luminaire is any one of the target luminaires; and regulate the dimming current of the first target luminaire according to the first regulation direction and the first regulation amount.

In a specific implementation of the second aspect, the regulation direction may be to increase the dimming current or to decrease the dimming current.

In a specific implementation of the second aspect, the regulation amount may be an absolute regulation amount or a relative regulation amount.

In accordance with a third aspect of the embodiments of the present application, a device for regulating a dimming current is provided, which may include: a configuration information acquisition unit and a dimming current regulation unit.

The configuration information acquisition unit is configured to obtain current regulation configuration information of target luminaires. Here, the target luminaires are luminaires powered by the dimmable power supply.

The dimming current regulation unit is configured to regulate the dimming current of each of the target luminaires according to the current regulation configuration information.

In a specific implementation of the third aspect, the dimmable power supply may include a first communication module.

The configuration information acquisition unit may be specifically configured to: perform, through the first communication module, information interaction with a second communication module in a configuration device that is configured in advance to obtain the current regulation configuration information stored in the configuration device.

In a specific implementation of the third aspect, the first communication module may be a first NFC module, and the second communication module may be a second NFC module.

In a specific implementation of the third aspect, the current regulation configuration information may include a regulation direction and a regulation amount of the dimming current.

The dimming current regulation unit may be specifically configured to: extract a first regulation direction and a first regulation amount corresponding to a first target luminaire from the current regulation configuration information, where the first target luminaire is any one of the target luminaires; and regulate the dimming current of the first target luminaire according to the first regulation direction and the first regulation amount.

In a specific implementation of the third aspect, the regulation direction may be to increase the dimming current or to decrease the dimming current.

In a specific implementation of the third aspect, the regulation amount may be an absolute regulation amount or a relative regulation amount.

In accordance with a fourth aspect of the embodiments of the present application, a computer-readable storage medium is provided. The computer-readable storage medium stores a computer program, and the computer program when executed by a processor, causes the steps of any of the above-mentioned dimming current regulation methods are implemented.

In accordance with a fifth aspect of the embodiments of the present application, a dimmable power supply is provided, which includes a memory, a processor, and a computer program stored in the memory and executable by the processor. The processor is configured to, when executing the computer program, implement the steps of any of the above-mentioned methods for regulating the dimming current.

In accordance with a sixth aspect of the embodiments of the present application, a computer program product is provided, which, when executed on a dimmable power supply, causes the dimmable power supply to perform the steps of any of the above-mentioned methods for regulating the dimming current.

Compared with the existing technologies, the embodiment of the present application has the following beneficial effects: the current regulation configuration information of various target luminaires is obtained in the embodiment of the present application. Here, the target luminaires are luminaires powered by a dimmable power supply. The dimming current of each of the target luminaires is regulated according to the current regulation configuration information. According to the embodiments of the present application, the corresponding current regulation configuration information may be pre-set according to the performance difference of each target luminaire. The dimmable power supply, after obtaining the current regulation configuration information, can regulate the dimming current of each of the target luminaires according to the current regulation configuration information, so that all the target luminaires can maintain strong consistency even in the deep dimming scenarios, effectively enhancing the user experience.

### BRIEF DESCRIPTION OF THE DRAWINGS

To more clearly illustrate the technical schemes in the embodiments of the present application, the drawings required for describing the embodiments are briefly introduced below. It is evident that the drawings described below are merely some embodiments of the present application. For ordinary technicians in this field, other drawings can be obtained based on these drawings without exerting creative efforts.

FIG. 1 is a schematic diagram of a system for regulating a dimming current in an embodiment of the present application;

FIG. 2 is a schematic flowchart of a method for regulating a dimming current applied to a dimmable power supply in an embodiment of the present application;

FIG. 3 is a schematic diagram of a user interacting with a configuration device through a user interface of the configuration device;

FIG. 4 is a schematic diagram of a dimmable power supply interacting with a second NFC module in the configuration device through a first NFC module;

FIG. 5 is a schematic flowchart of a dimmable power supply regulating a dimming current of any target luminaire according to current regulation configuration information;

FIG. 6 shows a schematic diagram of a situation where the target luminaires fail to achieve synchronized on/off effects before regulation;

FIG. 7 shows a schematic diagram of a situation where the target luminaires have uneven brightness levels before regulation;

FIG. 8 shows a schematic diagram of a situation where the target luminaires can achieve synchronized on/off effects after regulation while maintaining consistent brightness levels;

FIG. 9 is a schematic structural diagram of a device for regulating a dimming current in an embodiment of the present application; and

FIG. 10 is a schematic block diagram of a dimmable power supply in an embodiment of the present application.

### DETAILED DESCRIPTION OF THE EMBODIMENTS

To make the objectives, features, and advantages of the present application more apparent and easier to understand, the technical schemes in the embodiments of the present application will be clearly and comprehensively described below in conjunction with the drawings in the embodiments of the present application. Clearly, the embodiments described below are only a part of, rather than all of, the embodiments of the present application. Based on the embodiments in the present application, all other embodiments obtained by those of ordinary skill in the art without creative efforts shall fall within the protection scope of the present application.

It should be understood that when used in this specification and the appended claims, the term “including” indicates the presence of the described features, wholes, steps, operations, elements and/or components, but does not exclude the presence or addition of one or more other features, wholes, steps, operations, elements, components and/or their combinations.

It should also be understood that the terms used in this specification of the present application are only for the purpose of describing specific embodiments and are not intended to limit the present application. As used in the specification of the present application and the appended claims, the singular forms “a”, “an” and “the” are intended to include the plural forms unless the context clearly indicates otherwise.

It should be further understood that the term “and/or” used in this specification and the appended claims of the present application refers to any combination of one or more of the associated listed items and all possible combinations, and includes these combinations.

As used in this specification and the appended claims, the term “if” may be interpreted as “when . . . ” or “once” or “in response to determination” or “in response to detection” according to the context. Similarly, the phrase “if it is determined” or “if [the described condition or event] is detected” may be interpreted to mean “once it is determined” or “in response to determination” or “once [the described condition or event] is detected” or “in response to detection [the described condition or event]” according to the context.

In addition, in the description of the present application, the terms “first”, “second”, “third”, etc. are only used to distinguish the description, and cannot be understood as indicating or implying relative importance.

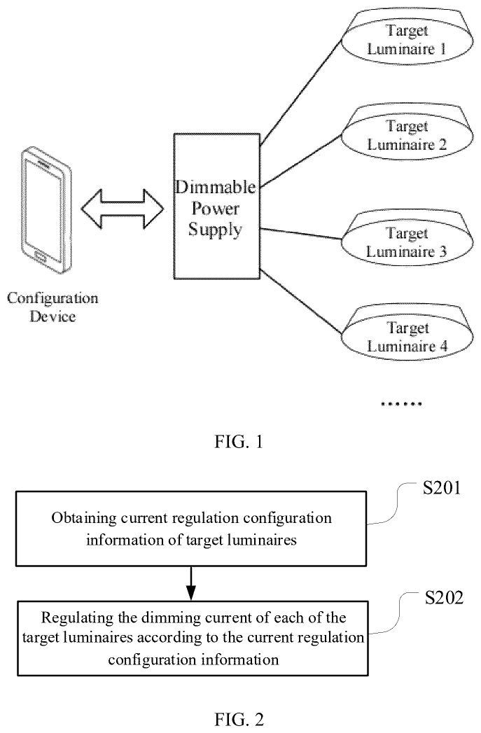

FIG. 1 shows a schematic diagram of a system for regulating a dimming current in an embodiment of the present application. As shown in FIG. 1, the system for regulating the dimming current may include: a configuration device, a dimmable power supply, and various target luminaire. Among them, the target luminaires are luminaires powered by a dimmable power supply, and each luminaire may be an LED luminaire. The configuration device is configured to store the current regulation configuration information of the target luminaires. The dimmable power supply is configured to obtain the current regulation configuration information stored in the configuration device, and regulate the dimming current of each of the target luminaires according to the current regulation configuration information. It should be noted that the four target luminaires shown in FIG. 1 are merely illustrative examples and do not impose any limitation on the specific number of target luminaires. Understandably, the specific number of target luminaires can be set according to actual conditions, and which is not specifically limited in the embodiments of the present application.

Referring to FIG. 2, a method for regulating a dimming current applied to a dimmable power supply in an embodiment of the present application may include steps S201 to S202.

In step S201, current regulation configuration information of target luminaires is obtained.

In a specific implementation of the embodiment of the present application, the current regulation configuration information of the target luminaires may be obtained from the configuration device by the dimmable power supply.

The configuration device may be any terminal device in the existing technologies, for example, the configuration device may include but is not limited to a mobile phone, a tablet computer, a smart bracelet, a smart watch or other terminal devices, and the embodiment of the present application does not specifically limit the type of the configuration device.

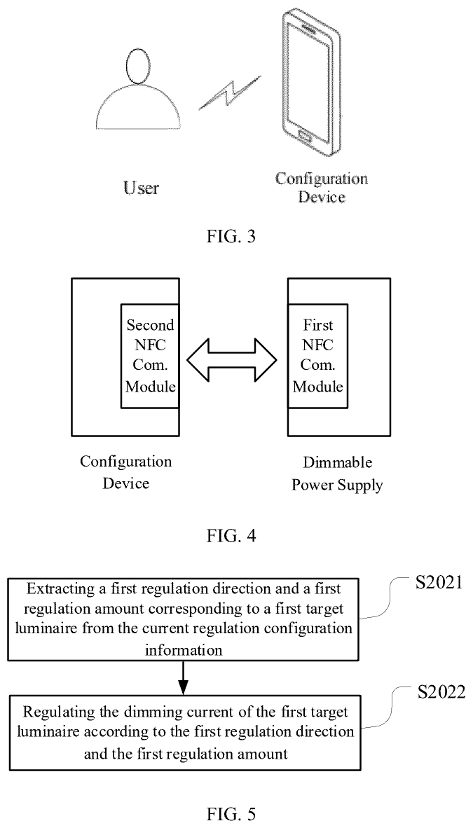

In a specific implementation of the embodiment of the present application, as shown in FIG. 3, the user may perform human-computer interaction with the configuration device through the user interface (UI) of the configuration device to input the current regulation configuration information of the target luminaires into the configuration device for storage.

For any given target luminaire, its corresponding current regulation configuration information can be obtained by the user through actual testing. For instance, the user may conduct performance tests on the actual usage of the target luminaire and determine the current regulation configuration information corresponding to the target luminaire according to the test results.

In a specific implementation of the embodiment of the present application, the dimmable power supply may include a first communication module. The configuration device may include a second communication module. The dimmable power supply may exchange information with the second communication module in the configuration device through the first communication module, to obtain the current regulation configuration information stored in the configuration device.

Herein, the specific communication mode adopted by the first communication module and the second communication module may be any communication mode in the existing technologies, including but not limited to Near Field Communication (NFC), Bluetooth, Frequency Modulation (FM), infrared technology (IR), Wireless Local Area Networks (WLAN) (e.g., Wireless Fidelity (WiFi)), or other communication methods.

Preferably, the first communication module and the second communication module may be communication modules implemented based on NFC technology. That is, the first communication module may be a first near field communication (NFC) module, and the second communication module may be a second NFC module. As shown in FIG. 4, the dimmable power supply may perform information interaction with the second NFC module in the configuration device through the first NFC module, to obtain the current regulation configuration information stored in the configuration device.

In step S202, a dimming current of each of the target luminaires is regulated according to the current regulation configuration information.

In a specific implementation of the embodiment of the present application, the current regulation configuration information may include a regulation direction and a regulation amount of the dimming current. Herein, the regulation direction may be to increase the dimming current or to decrease the dimming current. The regulation amount may be an absolute regulation amount or a relative regulation amount.

Taking the use of absolute regulation amount as an example, the following illustrates one possible current regulation configuration information:
(Target Luminaire 1) The regulation direction is: to increase dimming current; and the absolute regulation amount is: 1 mA;
(Target Luminaire 2) The regulation direction is: to increase dimming current; and the absolute regulation amount is: 0.1 mA;
(Target Luminaire 3) The regulation direction is: to decrease dimming current; and the absolute regulation amount is: 1 mA; and
(Target Luminaire 4) The regulation direction is: to decrease dimming current; and the absolute regulation amount is: 0.1 mA.

Taking the use of relative regulation amount as an example, the following illustrates one possible current regulation configuration information:
(Target Luminaire 1) The regulation direction is: to increase dimming current; and the relative regulation amount is: one thousandth;
(Target Luminaire 2) The regulation direction is: to increase dimming current; and the relative regulation amount is: one ten-thousandth;
(Target Luminaire 3) The regulation direction is: to decrease dimming current; and the relative regulation amount is: one thousandth; and
(Target Luminaire 4) The regulation direction is: to decrease dimming current; and the relative regulation amount is: one ten-thousandth.

Taking any target luminaire (denoted as the first target luminaire) as an example, the dimming current of this target luminaire may be regulated by the dimmable power supply through the process shown in FIG. 5.

In step S2021, a first regulation direction and a first regulation amount corresponding to a first target luminaire is extracted from the current regulation configuration information.

Taking the above current regulation configuration information using the absolute regulation amount as an example, if the first target luminaire is the target luminaire 1, then the first regulation direction extracted is to increase the dimming current, and the first regulation amount is 1 mA, that is, the dimming current needs to be increased by 1 mA. If the first target luminaire is the target luminaire 2, then the first regulation direction extracted is to increase the dimming current, and the first regulation amount is 0.1 mA, that is, the dimming current needs to be increased by 0.1 mA. If the first target luminaire is the target luminaire 3, then the first regulation direction extracted is to decrease the dimming current, and the first regulation amount is 1 mA, that is, the dimming current needs to be decreased by 1 mA. If the first target luminaire is the target luminaire 4, then the first regulation direction extracted is to decrease the dimming current, and the first regulation amount is 0.1 mA, that is, the dimming current needs to be decreased by 0.1 mA.

Taking the current regulation configuration information using the relative regulation amount as an example, if the first target luminaire is the target luminaire 1, then the first regulation direction extracted is to increase the dimming current, and the first regulation amount is one thousandth, that is, the dimming current needs to be increased by one thousandth. If the first target luminaire is the target luminaire 2, then the first regulation direction extracted is to increase the dimming current, and the first regulation amount is one ten-thousandth, that is, the dimming current needs to be increased by one ten-thousandth. If the first target luminaire is the target luminaire 3, then the first regulation direction extracted is to decrease the dimming current, and the first regulation amount is one thousandth, that is, the dimming current needs to be decreased by one thousandth. If the first target luminaire is the target luminaire 4, then the first regulation direction extracted is to decrease the dimming current, and the first regulation amount is one ten-thousandth, that is, the dimming current needs to be decreased by one ten-thousandth.

In step S2022, the dimming current of the first target luminaire is regulated according to the first regulation direction and the first regulation amount.

In a specific implementation of the embodiment of the present application, the dimming current of the first target luminaire may be regulated under the following four scenarios:

First scenario: the first regulation direction is to increase the dimming current, and the first regulation amount is an absolute regulation amount, then the dimming current of the first target luminaire may be regulated according to the following formula:

Dimming current after regulation=dimming current before regulation+first regulation amount.

Second scenario: the first regulation direction is to decrease the dimming current, and the first regulation amount is an absolute regulation amount, then the dimming current of the first target luminaire may be regulated according to the following formula:

Dimming current after regulation=dimming current before regulation−first regulation amount Third scenario: the first regulation direction is to increase the dimming current, and the first regulation amount is a relative regulation amount. Then the dimming current of the first target luminaire may be regulated according to the following formula:

Dimming current after regulation=dimming current before regulation×(1+first regulation amount)

Fourth scenario: the first regulation direction is to decrease the dimming current, and the first regulation amount is a relative regulation amount. Then the dimming current of the first target luminaire may be regulated according to the following formula:

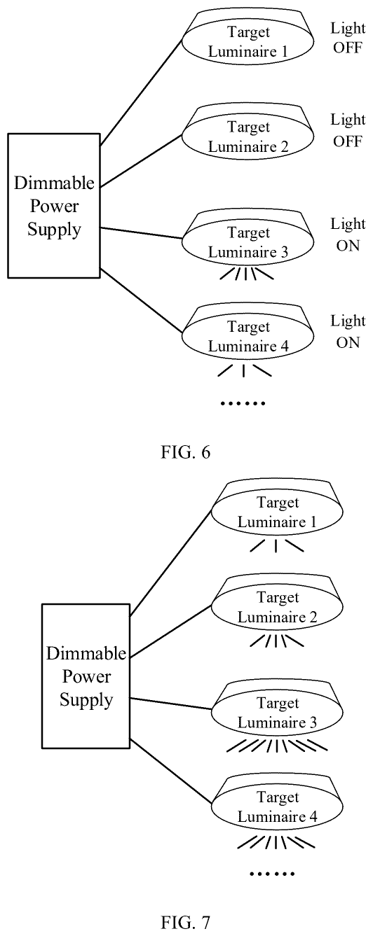

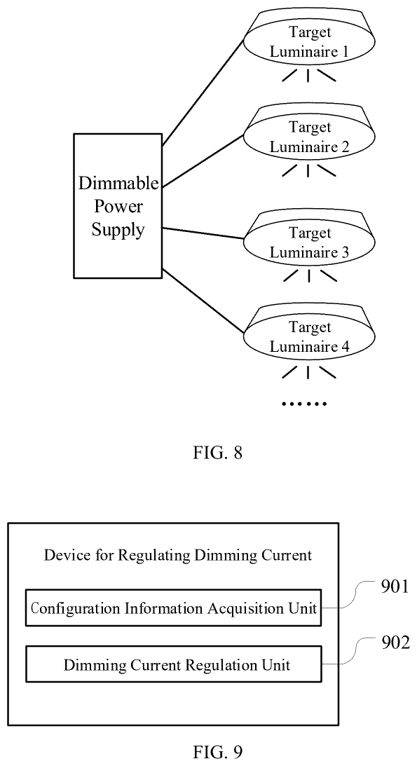

Dimming current after regulation=dimming current before regulation×(1−first regulation amount) The dimming current of each target luminaire may be regulated by the dimmable power supply according to the above process. The comparison effects before and after regulation are shown in FIGS. 6 to 8. Among them, as shown in FIG. 6, before the regulation, the target luminaires cannot achieve synchronized on/off effects. As shown in FIG. 7, prior to the regulation, even when all target luminaires are illuminated, their brightness levels appear uneven. As shown in FIG. 8, after the regulation, all target luminaires achieve synchronized on/off effects while maintaining consistent brightness levels.

In summary, in the embodiment of the present application, the current regulation configuration information of various target luminaires is obtained. The target luminaires are luminaires powered by the dimmable power supply. The dimming current of each of the target luminaires is regulated according to the current regulation configuration information. Through the embodiment of the present application, the corresponding current regulation configuration information may be pre-set according to the performance difference of each target luminaire. The dimmable power supply, after obtaining the current regulation configuration information, is capable of regulating the dimming current of each of the target luminaires according to the current regulation configuration information. This ensures that all target luminaires maintain strong consistency even in deep dimming scenarios, effectively enhancing the user experience.

It should be understood that the sequence numbers of the steps in the above embodiments do not imply an order of execution, and the execution sequence of each process should be determined by its function and internal logic, which should not impose any limitation on the implementation process of the embodiments of the present application.

Corresponding to the method for regulating the dimming current described in the above embodiment, FIG. 9 shows a structural diagram of a device for regulating a dimming current applied to a dimmable power supply provided by an embodiment of the present application.

In this embodiment, the device for regulating the dimming current may include: a configuration information acquisition unit 901 and a dimming current regulation unit 902.

The configuration information acquisition unit 901 is configured to obtain current regulation configuration information of target luminaires. The target luminaires are luminaires powered by the dimmable power supply.

The dimming current regulation unit 902 is configured to regulate the dimming current of each of the target luminaires according to the current regulation configuration information.

In a specific implementation of the embodiment of the present application, the dimmable power supply may include a first communication module.

The configuration information acquisition unit may be specifically configured to: perform information interaction with a second communication module in a configuration device that is configured in advance through the first communication module, to obtain the current regulation configuration information stored in the configuration device.

In a specific implementation of the embodiment of the present application, the first communication module may be a first NFC module, and the second communication module may be a second NFC module.

In a specific implementation of the embodiment of the present application, the current regulation configuration information may include a regulation direction and a regulation amount of the dimming current.

The dimming current regulation unit may be specifically configured to: extract a first regulation direction and a first regulation amount corresponding to a first target luminaire from the current regulation configuration information, where the first target luminaire is any one of the target luminaires; and regulate a dimming current of the first target luminaire according to the first regulation direction and the first regulation amount.

In a specific implementation of the embodiment of the present application, the regulation direction may be to increase the dimming current or to decrease the dimming current.

In a specific implementation of the embodiment of the present application, the regulation amount may be an absolute regulation amount or a relative regulation amount.

It can be clearly understood by persons skilled in the art that, for the convenience and simplicity of description, the specific working process of the above-described devices, modules and units can refer to the corresponding process in the aforementioned method embodiment, which will not be reiterated here.

In the above-mentioned embodiments, the description of each embodiment has its own emphasis. For the part that is not described or recorded in detail in a certain embodiment, reference may be made to the relevant description of other embodiments.

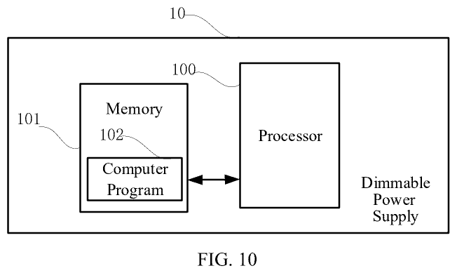

FIG. 10 shows a schematic block diagram of a dimmable power supply provided in an embodiment of the present application. For the convenience of explanation, only the part related to the embodiment of the present application is shown.

As shown in FIG. 10, the dimmable power supply 10 of this embodiment includes: a processor 100, a memory 101, and a computer program 102 stored in the memory 101 and executable by the processor 100. The processor 100 is configured to, when executing the computer program 102, implement steps of the method for regulating the dimming current in the above embodiments, such as steps S201 to S202 shown in FIG. 2. Alternatively, when the processor 100 executes the computer program 102, the functions of each module/unit in the above-mentioned device embodiments are implemented, such as the functions of modules 901 to modules 902 shown in FIG. 9.

Exemplarily, the computer program 102 may be divided into one or more modules/units, and the one or more modules/units are stored in the memory 101 and executed by the processor 100 to complete the present application. The one or more modules/units may be a series of computer program instruction segments capable of completing specific functions, and the instruction segments are used to describe the execution process of the computer program 102 in the dimmable power supply 10.

It can be understood by persons skilled in the art that FIG. 10 is only an example of the dimmable power supply 10 and does not constitute a limitation on the dimmable power supply 10. It may include more or fewer components than shown in the figure, or combine certain components, or different components. For example, the dimmable power supply 10 may also include input and output devices, network access devices, buses, etc.

The processor 100 may be a central processing unit (CPU), or other general-purpose processors, digital signal processors (DSP), application specific integrated circuits (ASIC), field programmable gate arrays (FPGA) or other programmable logic devices, discrete gates or transistor logic devices, discrete hardware components, etc. The general processor may be a microprocessor. Alternatively, the processor may be any conventional processor, etc.

The memory 101 may be an internal storage unit of the dimmable power supply 10, such as a hard disk or memory of the dimmable power supply 10. The memory 101 may also be an external storage device of the dimmable power supply 10, such as a plug-in hard disk, a smart memory card (Smart Media Card, SMC), a secure digital (Secure Digital, SD) card, a flash card (Flash Card), etc. equipped on the dimmable power supply 10. Further, the memory 101 may also include both the internal storage unit of the dimmable power supply 10 and an external storage device. The memory 101 is configured to store the computer program and other programs and data required by the dimmable power supply 10. The memory 101 may also be configured to temporarily store data that has been output or is to be output.

The technicians in the relevant field can clearly understand that for the convenience and simplicity of description, only the division of the above-mentioned functional units and modules is used as an example for illustration. In practical applications, the above-mentioned function allocation may be completed by different functional units and modules as needed, that is, the internal structure of the device may be divided into different functional units or modules to complete all or part of the functions described above. The functional units and modules in the embodiment may be integrated in one processing unit, or each unit may exist physically separately, or two or more units may be integrated in one unit. The above-mentioned integrated units may be implemented in the form of hardware or in the form of software functional units. In addition, the specific names of the functional units and modules are only for the convenience of distinguishing each other, and are not used to limit the protection scope of this application. The specific working process of the units and modules in the above-mentioned system can refer to the corresponding process in the aforementioned method embodiment, which will not be reiterated here.

In the above embodiments, the description of each embodiment has its own emphasis. For parts that are not described or recorded in a certain embodiment, reference may be made to the relevant description of other embodiments.

Ordinary technicians in this field can recognize that the units and algorithm steps of each example described in combination with the embodiments disclosed in this article may be implemented in electronic hardware, or a combination of computer software and electronic hardware. Whether these functions are executed in hardware or software depends on the specific application and design constraints of the technical scheme. Professional and technical personnel may employ different methods to implement the described functions for each specific application, but such implementation should not be considered to be beyond the scope of the present application.

In the embodiments provided in the present application, it should be understood that the disclosed device/dimmable power supply and method may be implemented in other ways. For example, the device/dimmable power supply embodiment described above is only schematic. For example, the division of the modules or units is only a logical function division. There may be other division methods in actual implementation, such as multiple units or components may be combined or integrated into another system, or some features may be ignored or not executed. Another point is that the mutual coupling or direct coupling or communication connection shown or discussed may be an indirect coupling or communication connection through some interfaces, devices or units, which may be electrical, mechanical or other forms.

The units described as separate components may or may not be physically separated, and the components displayed as units may or may not be physical units, that is, they may be located in one place, or they may be distributed on multiple network units. Some or all of the units may be selected according to actual requirements to achieve the purpose of the scheme of the embodiment.

In addition, each functional unit in each embodiment of the present application may be integrated into a processing unit, or each unit may exist physically separately, or two or more units may be integrated into one unit. The above-mentioned integrated unit may be implemented in the form of hardware or in the form of a software functional unit.

If the integrated module/unit is implemented in the form of a software functional unit and sold or used as an independent product, the integrated module/unit may be stored in a computer-readable storage medium. Based on this understanding, the present application implements all or part of the processes in the above-mentioned embodiment method, and may also be completed by instructing the relevant hardware through a computer program. The computer program may be stored in a computer-readable storage medium. When the computer program is executed by the processor, the steps of each of the above-mentioned method embodiments can be implemented. Among them, the computer program includes computer program code, and the computer program code may be in a source code form, an object code form, an executable file or some intermediate forms. The computer-readable storage medium may include: any entity or device that can carry the computer program code, a recording medium, USB flash drive, a mobile hard disk, disk, an optical disk, a computer memory, a read-only memory (ROM, Read-Only Memory), a random-access memory (RAM, Random Access Memory), an electric carrier signal, a telecommunication signal and a software distribution medium. It should be noted that the content contained in the computer-readable storage medium may be appropriately increased or decreased according to the requirements of legislation and patent practice in the jurisdiction. For example, in some jurisdictions, according to legislation and patent practice, computer-readable storage media do not include electric carrier signals and telecommunication signals.

The embodiments described above are only used to illustrate, rather than limit, the technical schemes of the present application. Although the present application has been described in detail with reference to the aforementioned embodiments, a person skilled in the art should understand that the technical schemes described in the aforementioned embodiments may still be modified, or some of the technical features may be substituted by equivalents. Such modifications or substitutions do not deviate the essence of the corresponding technical schemes from the spirit and scope of the technical schemes of the embodiments of the present application, and thus should all be included within the protection scope of the present application.

1. A method for regulating a dimming current, applied to a dimmable power supply that is configured in advance, and the method comprising:
obtaining current regulation configuration information of target luminaires; wherein the target luminaires are luminaires powered by the dimmable power supply; and
regulating the dimming current of each of the target luminaires according to the current regulation configuration information.

2. The method for regulating the dimming current according to claim 1, wherein the dimmable power supply comprises a first communication module;
the obtaining of the current regulation configuration information of the target luminaires comprises:
performing, through the first communication module, information interaction with a second communication module in a configuration device that is configured in advance to obtain the current regulation configuration information stored in the configuration device.

3. The method for regulating the dimming current according to claim 2, wherein the first communication module is a first near field communication (NFC) module, and the second communication module is a second NFC module.

4. The method for regulating the dimming current according to claim 1, wherein the current regulation configuration information comprises a regulation direction and a regulation amount of the dimming current;
the regulating the dimming current of each of the target luminaires according to the current regulation configuration information comprises:
extracting a first regulation direction and a first regulation amount corresponding to a first target luminaire from the current regulation configuration information, wherein the first target luminaire is any one of the target luminaires; and
regulating the dimming current of the first target luminaire according to the first regulation direction and the first regulation amount.

5. The method for regulating the dimming current according to claim 4, wherein the regulation direction is to increase the dimming current or to decrease the dimming current.

6. The method for regulating the dimming current according to claim 4, wherein the regulation amount is an absolute regulation amount or a relative regulation amount.

7. A system for regulating a dimming current, characterized comprising: a configuration device, a dimmable power supply and target luminaires; wherein the target luminaires are luminaires powered by the dimmable power supply;
the configuration device is configured to store current regulation configuration information of the target luminaires; and
the dimmable power supply is configured to obtain the current regulation configuration information stored in the configuration device, and regulate the dimming current of each of the target luminaires according to the current regulation configuration information.

8. The system for regulating the dimming current according to claim 7, wherein the dimmable power supply comprises a first communication module, and the configuration device comprises a second communication module;
the dimmable power supply is specifically configured to: perform, through the first communication module, information interaction with the second communication module to obtain the current regulation configuration information stored in the configuration device.

9. The system for regulating the dimming current according to claim 8, wherein the first communication module is a first NFC-communication module, and the second communication module is a second NFC communication module.

10. The system for regulating the dimming current according to claim 7, wherein the current regulation configuration information comprises a regulation direction and a regulation amount of the dimming current;
the dimmable power supply is further specifically configured to: extract a first regulation direction and a first regulation amount corresponding to a first target luminaire from the current regulation configuration information, wherein the first target luminaire is any one of the target luminaires; and regulate a dimming current of the first target luminaire according to the first regulation direction and the first regulation amount.

11. The system for regulating the dimming current according to claim 10, wherein the regulation direction is to increase the dimming current or to decrease the dimming current.

12. The system for regulating the dimming current according to claim 10, wherein the regulation amount is an absolute regulation amount or a relative regulation amount.

13. A device for regulating a dimming current, applied to a dimmable power supply that is configured in advance, and the device comprising:
a configuration information acquisition unit, configured to obtain current regulation configuration information of target luminaires, wherein the target luminaires are luminaires powered by the dimmable power supply; and
a dimming current regulation unit, configured to regulate the dimming current of each of the target luminaires according to the current regulation configuration information.

14. The device for regulating the dimming current according to claim 13, wherein the dimmable power supply comprises a first communication module;
the configuration information acquisition unit is specifically configured to: perform, through the first communication module, information interaction with a second communication module in a configuration device that is configured in advance to obtain the current regulation configuration information stored in the configuration device.

15. The device for regulating the dimming current according to claim 14, wherein the first communication module is a first NFC module, and the second communication module is a second NFC module.

16. The device for regulating the dimming current according to claim 13, wherein the current regulation configuration information comprises a regulation direction and a regulation amount of the dimming current;
the dimming current regulation unit is configured to: extract a first regulation direction and a first regulation amount corresponding to a first target luminaire from the current regulation configuration information, wherein the first target luminaire is any one of the target luminaires; and regulate the dimming current of the first target luminaire according to the first regulation direction and the first regulation amount.

17. The device for regulating the dimming current according to claim 16, wherein the regulation direction is to increase the dimming current or to decrease the dimming current.

18. The device for regulating the dimming current according to claim 16, wherein the regulation amount is an absolute regulation amount or a relative regulation amount.

19. A non-transitory computer-readable storage medium storing a computer program, wherein the computer program, when executed by a processor, causes steps of the method for regulating the dimming current according to claim 1 to be implemented.

20. A dimmable power supply, comprising a memory, a processor, and a computer program stored in the memory and executable by the processor, wherein the processor is configured to, when executing the computer program, implement the steps of the method for regulating the dimming current according to claim 1.
